(19) United States
(12) Patent Application Publication
(10) Pub. No.: US 2003/0205015 A1
(43) Pub. Date: Nov. 6, 2003

(54) Rail and stile kitchen cabinet and utility doors with interchangeable/reversible raised panel

(76) Inventors: Bill Birmingham, Fermeuse (CA); Paul Brown, St. John's (CA)

Correspondence Address: H. Roger Hart, Bereskin & Parr, Box 401, 40 King Street West, Toronto, ON, M5H 3Y2, CA

(21) Appl. No.: 10/136,301

(22) Filed: May 2, 2002

(51) Int. Cl. E06B 3/70

(52) U.S. Cl. 52/455

(57) ABSTRACT

The invention involves a rail and stile door panel of the type typically used for kitchen cabinets or utility storage cupboards. The door system includes a rail and stile framework in which a panel is mounted. The panel is held in place by a panel recess in one of the frame members and at least one key received in another of the frame members. The key has a tang which fits in a keyway. The panel is received in a panel recess comprised of horizontal and vertical abutment faces.

The panel can be removed, replaced or interchanged by removing the key. Upon removal of the key, the panel may be removed from the frame. If the panel is finished on both side, the panel may be reversed. If it is desired to use some other type of panel then a replacement panel may be installed in the frame.

Preferably the system includes three keys to support the retained panel all along its perimeter edge.

### FIELD OF THE INVENTION

The present invention relates generally to cabinet doors and more specifically to a door system in which the panel portion of the door can be replaced or reversed.

### BACKGROUND OF THE INVENTION

Cabinet doors have been used for many, many years. Typically cabinet doors as are used in kitchen cupboards, utility cupboards and the like, include rail and stile construction surrounding a panel. An example of a door that allows for removal of the panel section is illustrated in U.S. Pat. No. 4,158,277 issued Jun. 19, 1979 to Kremmp.

Conventional cabinet doors are manufactured from rail and stile construction with a central panel. The panels are usually located in troughs or grooves provided in the rails and stiles which holds the panel. Basically, the rails or stiles are glued or otherwise fastened together, and while often the panel may float within the frame, there is no intention that the frame be disassembled to change the panel. If it is desired to change the appearance of the door, the entire door must be either refinished or replaced. Finally,it is desirable to have a door system in which the panel is replaceable. Such a system is shown in Kremmp, U.S. Pat. No. 4,158,277. However, in the Kremmp system, removal of the panel is accomplished by removing flush mounted screws from a portion of the frame. That portion of the frame is then removed. The panel can then be slid out of the remainder of the frame. This type of construction provides for some ability to replace the panel. However, the replaceable panel must be such that it can be slid by the remainder of the frame. This may limit the features that may be provided on the panel which are otherwise aesthetically desirable.

Accordingly, there is a need for a door system in which the door panel is easily removable so that the door panel can be replaced with another door panel or reversed to show an alternate face.

### SUMMARY OF THE INVENTION

In accordance with this invention, a door system is disclosed. The door system includes a frame, a panel and at least one removable key for retaining the panel in the frame. The frame includes a top member, a bottom member and first and second side members. At least one of the top, bottom, first and second side members includes a panel slot for receiving an edge of the panel. The other of the top, bottom and first and second panels include a respective alignment recess for receiving the other respective edges of the panel. At least the member opposite the member having the panel slot comprises a keyway for receiving the key.

In accordance with a particular preferred embodiment of the invention, the door system includes a frame, a panel and three removable keys for retaining the panel in the frame. The top member of the frame includes a panel slot for receiving a top edge of the panel. The bottom member and the first and second side members each include an alignment recess for receiving respective edges of the panel. The first and second side members and the bottom member also include a keyway for receiving one of three keys. The system includes a first key having a length substantially equal to the span of the bottom panel and two keys having a length substantially equal to the vertical length of the first and second side members.

### DETAILED DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein,

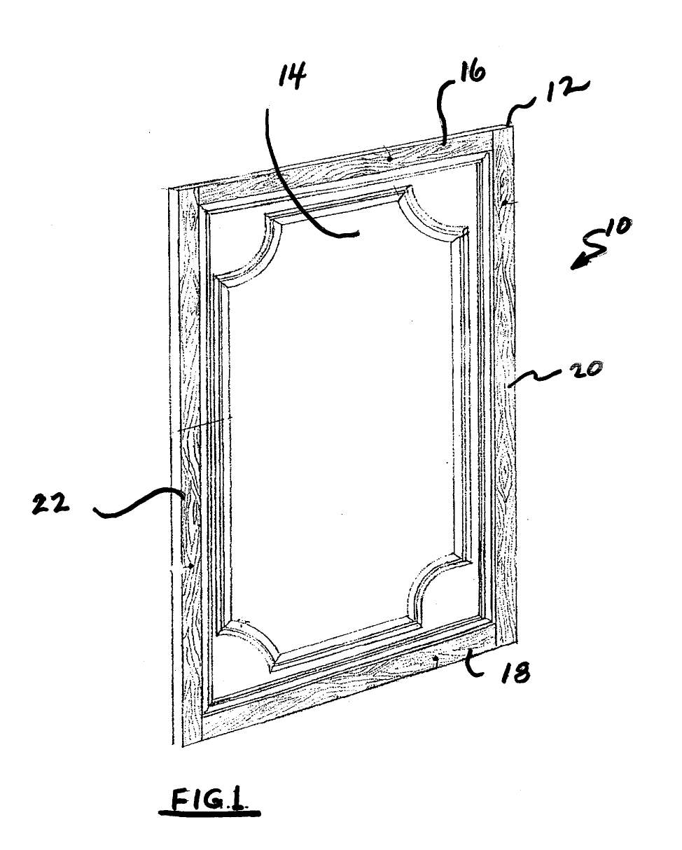

FIG. 1 is a front perspective view of a preferred embodiment of the system in accordance with the invention;

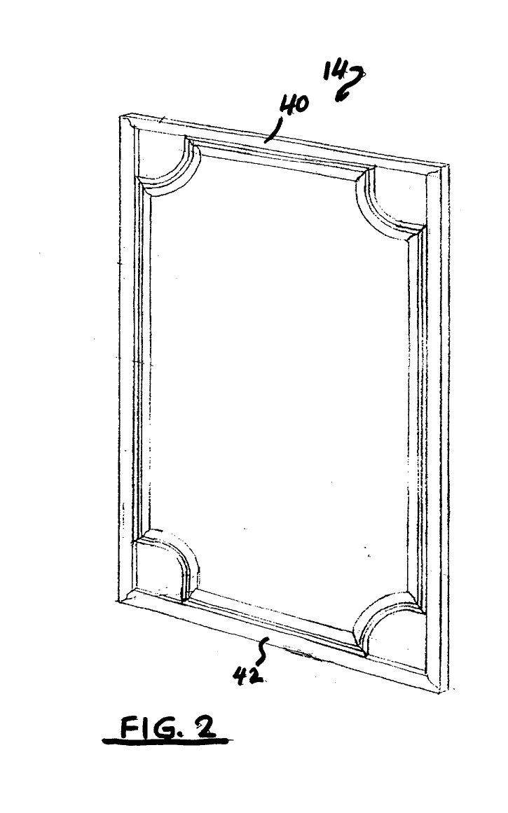

FIG. 2 is a perspective view of one of the components of the door system of FIG. 1;

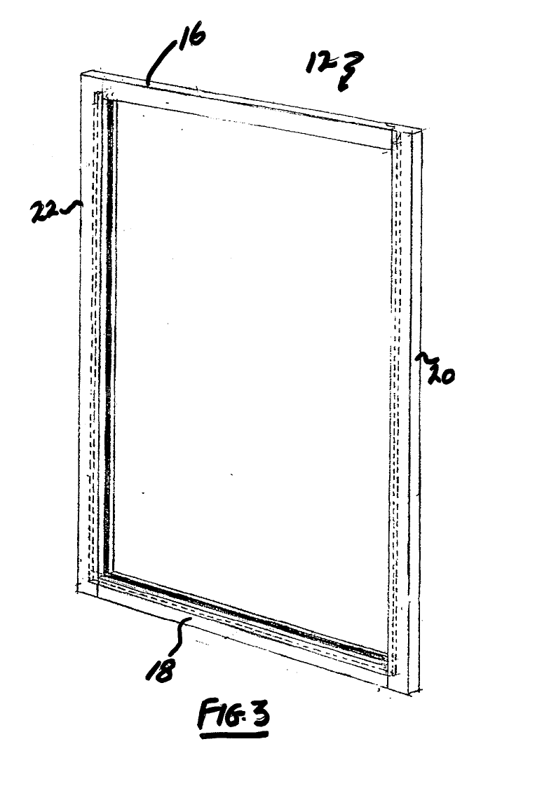

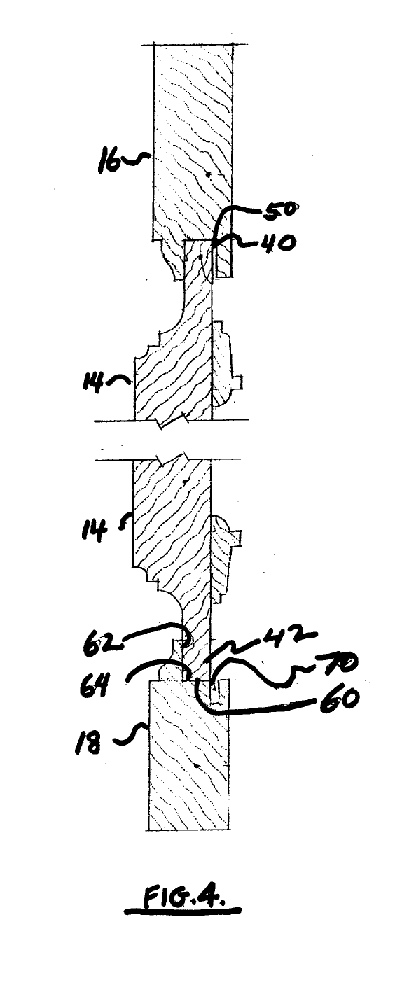

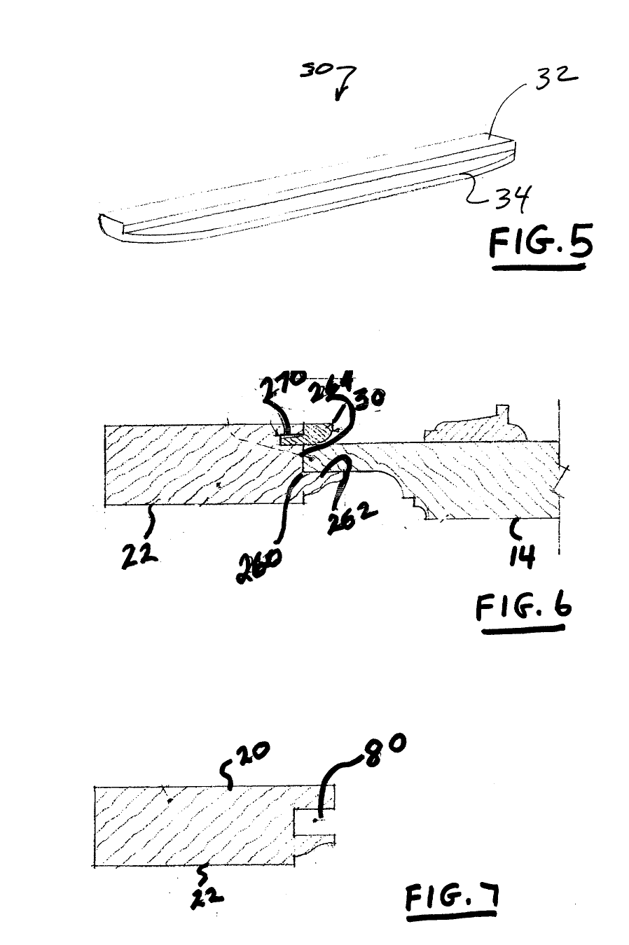

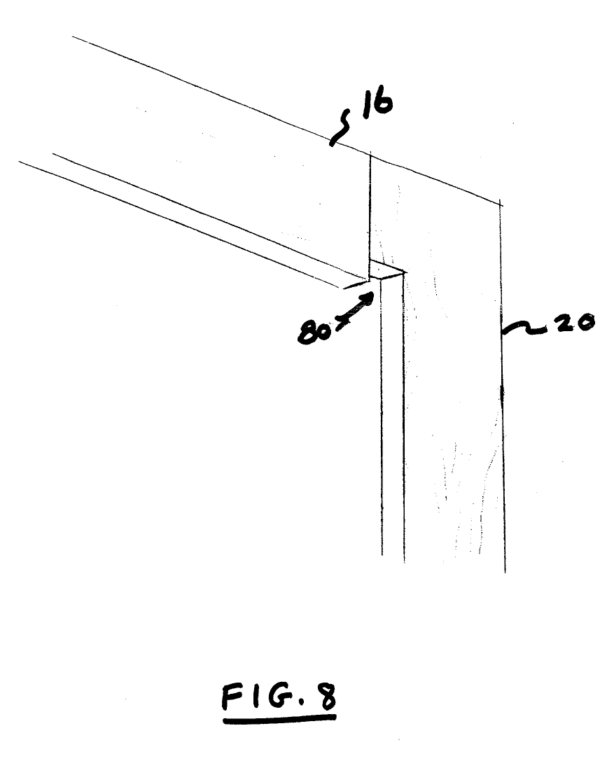

FIG. 3 is a perspective view of another of the components of FIG. 1;

FIG. 4 is a split vertical section along the line 4-4 of FIG. 1;

FIG. 5 is a perspective view of another of the components of the system of FIG. 1;

FIG. 6 is a cross-section of a portion of the system of FIG. 1 taken along line 6-6; and

FIG. 7 is a cross-sectional view of one of the components of the assembly shown in cross-section in FIG. 6.

### DETAILED DESCRIPTION OF THE INVENTION

The door system is illustrated generally at 10. The door system includes a frame 12 and a panel 14. The door frame, comprises a top member 16 often referred to as a rail, a bottom member 18 also often referred to as a rail, a first side member 20, often referred to as a stile and a second side member 22, also often referred to as a stile.

In the embodiment illustrated in FIG. 1, the top member 16 is shown as a single longitudinally extending member. The top member 16 however could be a curved member if it is desired that the door system have some other configuration. Often doors have a cathedral-like arch at the upper portion. The door system as illustrated in FIG. 1 is simplified but is equally applicable to a door system having a more complex top system. Although unusual, the top member could in fact be an equilateral triangle which would still permit the panel to be reversed. If the door system has an asymmetric top shape, then the panel can be replaced but would not be reversible.

FIG. 5 illustrates one of the keys 30 which forms a part of the door system.

As shown in FIG. 4, the panel 14 has top and bottom edges 40 and 42 respectively. The top and bottom edges are relatively narrow in front to back width. As shown in FIG. 4, the edge 40 along the top of the panel 14 is received within a panel recess 50 which can be routed in the inner surface of the top member 16. The panel recess 50 extends the width of the top member 16 between the assembled width of the side members 20 and 22. When the panel 14 is assembled to the frame 12, the panel is installed with the edge 40 slid into the panel recess 50.

From review of FIG. 4, it will be noted that bottom member 14 includes an alignment recess indicated generally at 60. Alignment recess 60 in bottom member 50 includes a vertical abutment surface 62 and a horizontal or transverse abutment surface 64. The bottom member 18 also includes a keyway 70. The alignment recess 60 may be milled into the edge of the bottom member 18. Similarly the keyway 70 may be milled or routed into the abutment surface 64. Preferably the keyway 70 is located in the abutment surface 64 so that when the panel 14 is assembled to the bottom member 18, the key 30 when inserted into the keyway 70 will bear against the edge 42 of the panel 14.

In the preferred embodiment illustrated in these figures, the door system comprises three keys 30 and the three keys 30 are installed in similar keyways 70 in each of the bottom member 18 and in the two side members 20 and 22. FIG. 6 illustrates the assembly of the panel 14 with the side member 22 and one of the keys 30. The side member 22 includes an alignment recess 260 which is comprised of a first abutment surface 262 and a second abutment surface 264 as well as a keyway 270. The arrangement of the keyway 270 with respect to the abutment surfaces 262 and 264 is the same as that shown with respect to the bottom member with its keyway 70 and the abutment surfaces 62 and 64.

It will be recognized that a sectional view showing the assembly of the panel 14 with the side member 20 would be a mirror image of FIG. 6.

FIGS. 7 and 8 illustrate the side member 20 adjacent the position where the upper edge 40 of the panel 14 will be upon assembly. The side member 20 has a notch 80 at the upper portion thereof. This is shown more clearly in FIG. 8. For simplicity purposes, in FIG. 8, the panel slot has not been illustrated. Similarly, for simplicity purposes, in FIG. 8 the abutment surfaces 62 and 64 and the keyway 70 are not illustrated. However, as shown in FIG. 8, the length of the key which is to be used with the side member 20 is such that the top end of the key will be held in place from sideways movement by the edge of the top member 16.

With the above description of the preferred embodiment in mind, it will now be appreciated how the door system may be assembled. The door system is made by first making the components of the frame. When the top member 16, bottom member 18, first side member 20 and second side member 22 have been manufactured, these are joined together using any typical joinery methods desired. This may involve mortice and tennon joints or any other suitable joining system. The joints may be glued or held by fasteners such as screws or any combination. Once the frame has been permanently assembled, then the panel 14 can be placed within the frame. The panel 14 is placed within the frame by guiding the end 40 up into the panel recess 50 of the top member 16. The panel is placed by moving it from the rear surface of the finished door toward the top member 16. When the edge 40 is received within the panel slot 50, the panel 14 is moved forward until the end 42 is received in and lays against the abutment surface 62. Proper dimensioning of the frame and panel will leave the bottom edge of the end 42 resting against the abutment surface 64. Similarly, the side edge portions of the door will be received in the abutment surfaces of the side members 20 and 22, one of which is shown in FIG. 6. With the panel in place and sitting against the respective abutment surfaces, the first key can be assembled to either the side 20 or 22. The first key 30 has a length approximately equal to the length of the abutment surface 264 of side panel 22, by way of example. This means that the lower portion of the key would sit adjacent the abutment surface 64 of the bottom member 18 and the top edge of the key will be received in the recess 80. The next step in the assembly is to assemble the second key 30 in the other side 20 so that the two side keys are positioned in place. The final step in the assembly is then to place the bottom key 30 into the keyway 70 of the bottom member 18. The bottom key 30 has a length substantially equal to the length of the abutment surface 64 except for the width of the first and second keys. The bottom key then bears against the first and second keys which have been installed on the side members.

With this arrangement, the keys can generally be inserted within the respective keyways 70, 270, etc. The key 30 as shown in FIG. 5 includes a body portion 32 and a tang portion 34. The tang portion 34 is received in the respective keyways 70, 270 and on the other side member. With the arrangement shown in the figures and as discussed above, the keys are held in place by gravity. The side keys cannot pivot sideways as they are held by the notches 80 in the respective side members and by the bottom key 30.

By using a panel recess 50 and three keys 30, the panel is supported around the perimeter edge of the panel. This will serve to ensure that the panel does not rattle within the frame as the door is opened and closed. Additionally, this will serve to inhibit the panel from warping which may occur depending upon the material from which the panel 14 is made.

The material from which the door system may be made is entirely a matter of choice. The material of the frame and the panel may be wood, glass, plastic, medium density fibreboard, metals or any combinations thereof, or any other material that can be formed into rails, stiles, panels and keys respectively.

Depending upon the material from which the panel 14 is made, it may not be necessary to support the panel on all three perimeter edges. This may be particularly true where the panel is made of a material or the door system is used in circumstances where warping will not be a problem. In such circumstances, at least one of the top, bottom or first and second side members should be held in a panel recess similar to recess 40 illustrated in top 50. In order to hold the panel in place, then whatever member is opposite the member having the panel recess, should then be provided with a keyway 70 for receiving at least one key 30. As long as the panel is held on two opposite edges, the panel will be held in the frame. Thus, depending upon the orientation and the space available, the panel recess could be on the bottom or first or second side, by way of example, and the keyway would then be respectively on the top, second or first side. In each case the keyway would be on the member opposite the member having the panel recess.

When only one key is required it may be desirable to ensure that the keyway and the key are arranged to have an interference fit. In this way, the key can be retained in the keyway by driving the key into the keyway so that the key is deformed in some way as to be retained by the keyway 70. With this type of mounting system, the keys need not have any particular length and the length can be selected to provide a suitable retention without necessarily extending the length of the member in which the keyway is installed.

With respect to the above description, it is to be realized that the optimum dimensional relationship for the parts of the invention, to include variations in size, materials, shape, form, function and manner of operation, assembly and use, are deemed readily apparent and obvious to one skilled in the art and all equivalent relationships to those illustrated in the drawings and described in the specification are intended to be encompassed within the present invention.

Therefore, the foregoing is considered as illustrative only of the principals of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention as set out in the appended claims.

We claim:

1. A door system,
said door system comprising a frame and a panel and at least one removable key for retaining said panel in said frame,
same frame comprising a top member, a bottom member and first and second side members,
one of said top, bottom and first and second side members comprising a panel slot for receiving an edge of said panel, the other of said top, bottom and first and second members including an alignment recess for receiving respective edges of said panel, and wherein the member opposite said member comprising a panel slot, having a keyway for receiving said key.

2. The door system of claim 1 wherein said system comprises at least one addition key and at least one of said top, bottom, first and second side member which is not either the member having a panel slot or the member opposite said member having a panel slot, also has a keyway for receiving said at least one additional key.

3. The door system of claim 1 wherein one of said members includes a panel slot and the other of said members include a keyway and said system includes three keys.

4. The door system of claim 1 wherein said alignment recess comprises first and second abutment surfaces.

5. The door system of claim 4 wherein said keyway comprises a slot in said second abutment surface.

6. The door system of claim 4 wherein said keyway is located in said first abutment surface adjacent to said panel.

7. The door system of claim 1 wherein said panel has a finished front and finished back so that said panel can be reversed.

8. The door system of claim 1 wherein the door system comprises at least two panels and said panels are interchangeable.

9. The door system of claim 1 wherein there is an interference fit between said key and said keyway.

10. The door system of claim 3 wherein said panel slot is in said top member and each of said first and second side members include a notch adjacent said top member to accommodate an end of said key received within said keyway of said first and second side members.
